(19) United States
(12) Patent Application Publication
(10) Pub. No.: US 2015/0070304 A1
(43) Pub. Date: Mar. 12, 2015

(54) Capacitive touch device brush stylus

(71) Applicant: Vorbeck Materials, Jessup, MD (US)

(72) Inventors: John Lettow, Washington, DC (US); Anthony Parham, Ellicott City, MD (US); Kate Redmond, Baltimore, MD (US); Dan Scheffer, Frederick, MD (US); George Tunis, Pocomoke City, MD (US)

(21) Appl. No.: 14/395,060

(22) PCT Filed: Apr. 16, 2013
(86) PCT No.: PCT/US13/36778

§ 371 Date: Oct. 16, 2014

Related U.S. Application Data
(60) Provisional application No. 61/624,782, filed on Apr. 16, 2012.
(60) Provisional application No. 61/624,809, filed on Apr. 16, 2012.

(51) Int. Cl. G06F 3/0354; G06F 3/044; G06F 3/041

(52) U.S. Cl. CPC G06F 3/03545; G06F 3/0412; G06F 3/044
USPC 345/174; 345/179; 29/825

(57) ABSTRACT

Capacitive touch device styluses, comprising brushes comprising bristles coated with an electrically conductive coating.

### REFERENCE TO RELATED APPLICATIONS

The present application claims priority to U.S. Provisional Applications 61/624,782, filed on Apr. 16, 2012 and 61/624,809, filed on Apr. 16, 2012, the entire contents of which are hereby incorporated by reference.

### FIELD OF THE INVENTION

The present invention relates to a capacitive touch device stylus comprising a brush having bristles coated with an electrically conductive coating.

### BACKGROUND

Capacitive touch devices such as touchscreen-containing electronics (such as computer displays, tablet computers, smartphones, etc.) are rapidly becoming more commonplace. Many of these are primarily operated by the user's finger or thumb, but for many applications it would be desirable to having different ways to operate them, such as by using of styluses. A stylus having a brush at one end would be desirable. Among many uses, it would allow for ease in forming characters, calligraphy, and painting and drawing.

### SUMMARY OF THE INVENTION

Disclosed and claimed herein is a capacitive touch device stylus, comprising a brush comprising bristles coated with an electrically conductive coating. Further disclosed and claimed are a method of making a capacitive touch device stylus, comprising forming a brush from a plurality of bristles, at least a portion of which have been coated with an electrically conductive coating and connecting the brush to a handle through an electrically conductive pathway; a method of making a capacitive touch device stylus, comprising forming a brush from a plurality of bristles, connecting the brush to a handle through an electrically conductive pathway, and coating the bristles with an electrically conductive coating; and a method of operating a capacitive touch device using a stylus having a brush comprising bristles coated with an electrically conductive coating connected to a handle via an electrical conductive pathway, wherein a user contacts the handle with a body part while simultaneously contacting the capacitive touch device with the brush.

### BRIEF DESCRIPTION OF THE DRAWINGS

FIG. 1a shows a brush stylus of the present invention.

FIG. 1b shows a brush stylus having a ferrule.

FIG. 2 shows the use of a brush stylus of the present invention with a capacitive touch device.

FIG. 3 shows a brush stylus having partially electrically conductive handle.

FIG. 4 shows a brush stylus having an electrically conductive core.

FIG. 5 shows a brush stylus having a combined with a writing implement.

FIG. 6 shows a brush stylus having two brushes.

FIG. 7 shows two tethered brush styluses.

FIG. 8 shows a brush stylus with an extender.

### DETAILED DESCRIPTION OF THE INVENTION

The capacitive touch device stylus of the present invention comprises a brush having electrically conductive bristles. By “capacitive touch device” is meant a device having a capacitive touch sensor. Examples include devices having touch screens, touch pads, capacitive keyboards, track pads, other touch-sensitive pointing or input devices, multi-touch sensors (such as multi-touch screen, displays, etc.), and the like.

Examples of devices include touch screen displays (such as computer monitors, televisions, laptop computer screens, etc.), laptop computer touch pads, tablet computers, cellular telephones and smartphones, personal digital assistants (PDAs), GPS receivers and navigation devices, e-readers, music (e.g. MP3) players, video game devices and consoles, hand-held video game consoles, point of sale devices and signature collectors, voting machines, ATMs, kiosks, etc. These can be devices such as iPods, iPhones, iTouches, Kindles, Android smartphones, Blackberries, Windows smartphones, etc. They can be devices that run on iOS, Android, Windows operating systems, etc.

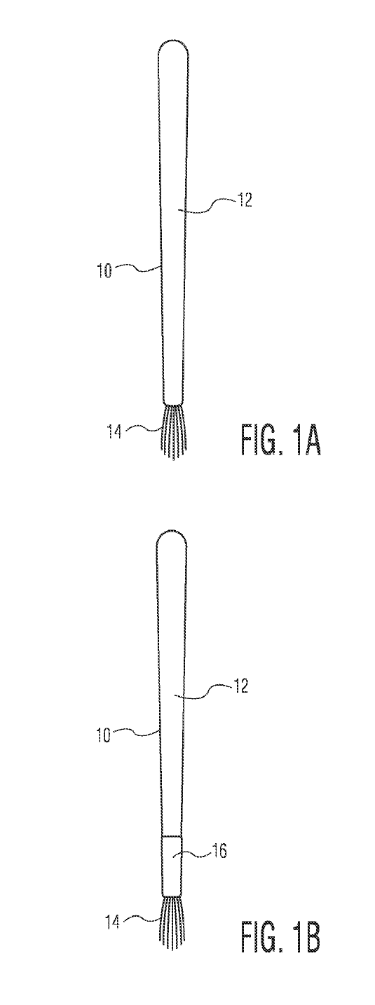

FIG. 1a shows a brush stylus 10 having handle 12 and electrically conductive bristles 14 attached thereto. As shown in FIG. 1 b, a ferrule 16 can connect handle 12 and bristles 14. The stylus can be used to replace one or more fingers, for example for operating a capacitive touch device. The stylus can be held by a hand, fingers, foot, toes, or other body parts. The stylus can also be operated by contacting it with a capacitive entity other than a human (or non-human) body part.

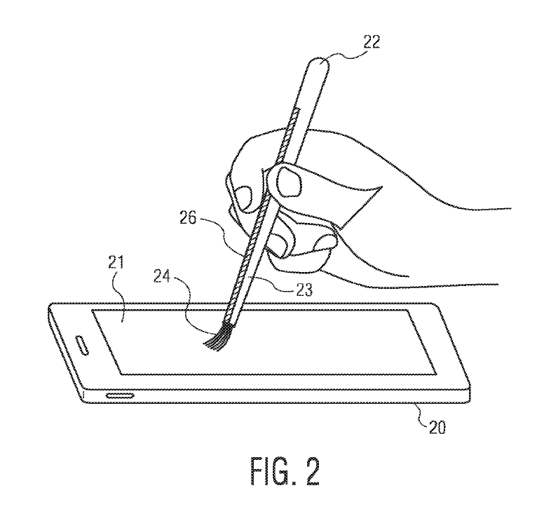

The stylus can be operated by contacting a portion of the handle with a capacitive entity (such as a human body, and particularly its skin) and a portion of the bristles with the capacitive touch device. For example FIG. 2 shows the use of stylus 22 with capacitive touch device 20, where the user holds the stylus by handle 23 and contacts bristles 24 with touch screen 21. The user's finger makes contact with an electrically conductive pathway 26 in or on the handle that leads to bristles and, in turn, the capacitive touch device when the bristles are in contact with the device.

The electrically conductive pathway preferably has a resistance of less than about 10 MOhm, or less than about 5 MOhm, or less than about 1 MOhm, or less than about 500 kOhm or less than about 200 kOhm, or less than about 100 kOhm, or less than about 50 kOhm, or less than about 10 kOhm, or less than about 1 kOhm, or less than about 500 Ohm, or less than about 100 Ohm.

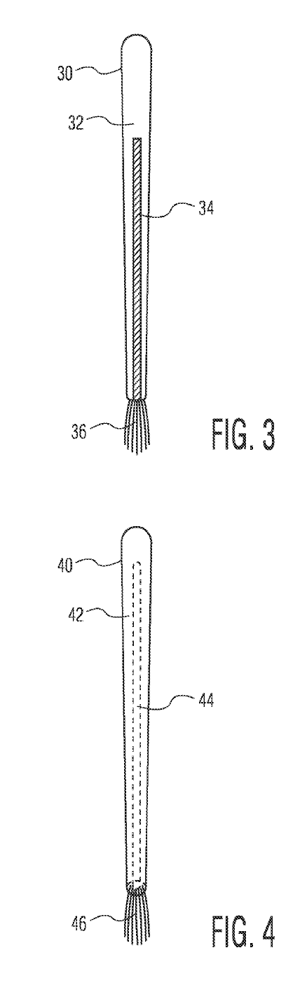

There are no particular limitations to the handle material. It may be solid, hollow, made from two or more materials, etc. It may be made from one or more intrinsically electrically conductive materials. The entire handle may be electrically connected to the bristles or only a portion of it may be. Examples of handle materials include one or more of wood (such as bamboo), plastics and filled plastics (such as plastics filled with graphene sheets), rubbers and filled rubbers (such as rubbers filled with graphene sheets), carbon, carbon-fiber composites, metal (such as aluminum, steel, stainless steel, etc.). The handle may be made from multiple materials that can be laminated laterally or in a concentric fashion. If the handle comprises a non-electrically conductive material, it can be layered with an electrically conductive material. For example, a handle made from a non-electrically conductive material can be fully or partially coated with an electrically conductive coating or covered with an electrically conductive foil. Handles containing non-electrically conductive materials can incorporate electrically conductive materials (such as metals). FIG. 3 illustrates a brush stylus 30 having an non-electrically conductive handle portion 32 and an electrically conductive handle portion 34 that is exposed to the surface and that makes an electrical connection with bristles 36. When used to operate a capacitive touch device, the capacitive entity (e.g. human body) contacts the electrically conductive handle portion.

In some embodiments, the electrically conductive handle portion is preferably directly contacted by, for example, bare skin. In other embodiments, the capacitive entity (e.g. human body part, such as a hand, fingers, etc.) does not need to contact the electrically conductive handle portion directly, but can do so through one or more insulating materials. For example, the user can use the stylus while wearing gloves, mittens, socks, or other clothing and through materials such as cloth, leather, rubber, plastics, etc. In some embodiments, the electrically conductive handle portion can be covered by an insulating material. For example, it may be a core of the handle that is surrounded by a non-conductive material, or if on the exterior of the handle, it may be painted or otherwise coated. FIG. 4 illustrates a brush stylus 40 having an non-electrically conductive handle portion 42 and an electrically conductive handle core 44 that makes an electrical connection with bristles 46.

The handle can be connected directly to the bristles, or a ferrule (such as a metal (e.g., aluminum, stainless steel, nickel, copper, nickel-plated steel, etc.), plastic, rubber, etc. ferrule) or other connector can be used to join them. The components (handle, bristles, and other connectors such as ferrules) can be joined by any appropriate means such as by friction, adhesive (including electrically conductive adhesives), tapes, wires, etc.

There are no particular limitations to the size, length, shape, etc. of the handle. It may bend, fold, telescope, etc. There are no particular limitations to the handle material. It may be solid, hollow, made from two or more materials, etc. Examples of handle materials include one or more of woods (such as bamboo), plastics, metals (such as aluminum, magnesium alloys, steel, stainless steel, etc.). The handle may comprise one or more electrically insulating materials. Handles can take on a variety of shapes and need not look like a traditional paint brush with a rod-like handle. For example, they can have disk- or wafer-shaped handles or have a quill-type shape. They can be round, square, hexagonal, oval, irregular, etc. in cross-section.

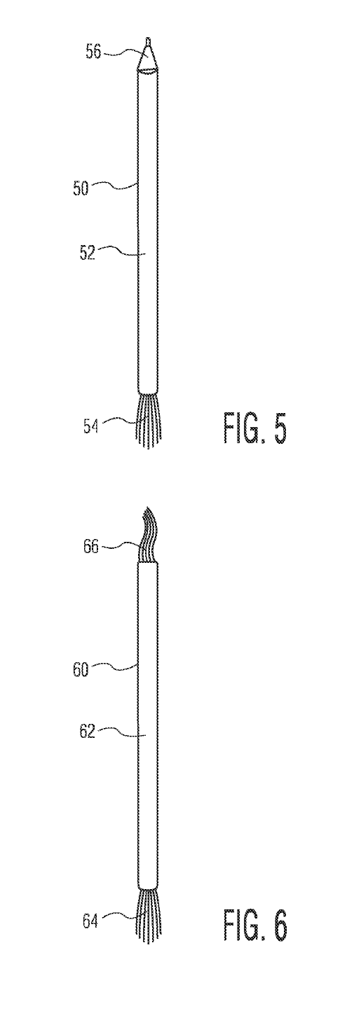

The brush stylus may also comprise other components, such as traditional writing implements (e.g. pens, pencils, markers, highlighters, etc.), laser pointers, flashlights, tools (such as screwdrivers), other types of styluses (such as a hard stylus or non-brush stylus), etc. FIG. 5 shows a stylus 50 having handle 52, electrically conductive bristles 54, and ink pen 56. The stylus may also comprise two or more brushes, including that those having different shapes or sized. FIG. 6 shows a stylus 60 having handle 62, and sets of bristles 64 and 66. The styluses may be designed to fold, telescope, collapse, etc.

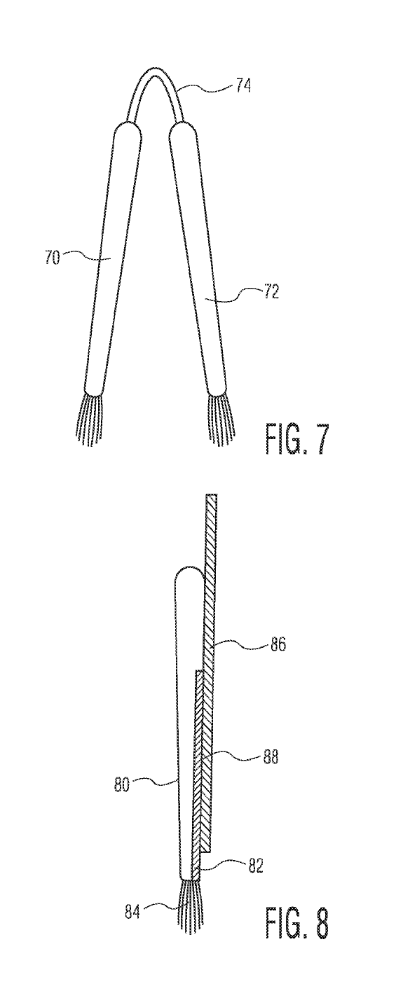

Two or more brush styluses can be used for multi-touch applications. Two or more styluses can be tethered as shown in FIG. 7, where styluses 70 and 72 are joined by a tether 74. In some embodiments the tether can create an electrically conductive pathway between the bristle of the two brushes.

The brush styluses can be used to operate capacitive touch devices in any suitable ways. For example, they can be used with software for painting, drawing, calligraphy, writing Asian language (such as Chinese, Japanese, Korea, etc.) characters, etc. They can be used with devices that are sensitive to applied pressure and/or applied surface area. In such cases, for example, the brush styluses could more realistically mimic a painting, drawing, or calligraphic effect.

The bristles may be made from any suitable material, including fibers and filaments. They may be natural, synthetic, or a mixture. Examples of natural bristles include China black and white China bristles and hog, sable, squirrel, badger, pony, horse, goat, mongoose, etc. hairs. Examples of synthetic bristle materials are nylons (polyamides), polyesters (such as Taklon), blends of nylons and polyesters, etc. The brushes may take on a wide variety of shapes and stiffnesses and the bristles may have a wide range of shapes and sizes. The bristles may have different sizes and cross sections. Individual bristles may be made from two or more filaments.

The bristles are made electrically conductive by coating fibers with a electrically conductive coating. The fibers can be coated prior to assembly into bristles, after they have been assembled into bristles, after they have been attached to a handle, at multiple times, etc. Different bristles may have different coatings. Ferrules or other attachment devices or means can be used to attach the bristles to the handle. The bristles may also be wired, clamped, glued, on etc. Electrically conductive glues and adhesives can be used. Not all of the bristles need be electrically conductive. Long filaments may be coated and then cut into appropriate sizes for use as bristles. If an electrically conductive (e.g. metal) ferrule or other attaching device is used, in some embodiments it need not be coated. Similarly, a handle that is partially or fully electrically conductive need not be coated in some embodiments. If the handle and/or ferrule or other attaching device or means are coated with an electrically conductive coating, the same coating does not need to be used for the bristles, handle, and/or ferrule. Any suitable method of assembly may be used. A few examples include, but are not limited to, the following: uncoated bristles are attached to a non-conductive handle with or without a ferrule and the bristles, handle, and, optionally, ferrule are coated with an electrically conductive coating; uncoated bristles are attached to a conductive handle with or without a ferrule and the bristles are coated with an electrically conductive coating; uncoated bristles are attached to a conductive handle with or without a ferrule and the bristles are coated with an electrically conductive coating; coated bristles are attached to a conductive handle with or without a ferrule; coated bristles are attached to a non-conductive handle with or without a ferrule and the handle (and in some cases the ferrule) is coated; etc.

Different coatings can be used for different components of the brushes. Different coatings can be used for different bristles.

In some cases the handle, ferrule, and/or other component of the brush may be overcoated, overvarnished, painted, or otherwise covered (such as with paper, foil, rubber, tape, etc.) after coating.

In some embodiments, a length extender may be affixed to the handle of the stylus, such that it is contact with at least a portion of the handle contain an electrically conductive component that is electrically connected to the bristles. In some embodiments, there may be an insulating layer between the extender and the actual electrically conductive component of the handle. For example, FIG. 8 shows a stylus 80 that has an electrically conductive handle portion 82 that is in electrical contact with bristles 84. Extender 86 is contacted with handle portion 82 at interface 88. The extender may be permanently or temporarily held in place. The extender can be an insulating material such as a plastic (including polyacrylates, polycarbonates, polyesters, etc.). When held by the extender, the stylus can be used with a capacitive touch device. As such, it could, for example, be used as pointer during presentations or to access touch screen displays and devices or touchpads from a distance.

The coatings can be based on any suitable medium, including coatings, inks, powders, etc. The coatings are electrically conductive. The coatings are compositions comprising at least one electrically conductive component and, optionally one or more binders, solvents, and/or other components. As used herein, the term “coating” refers to compositions that are in a form that is suitable for application to a substrate as well as the material after it is applied to the substrate, while it is being applied to the substrate, and both before and after any post-application treatments (such as evaporation, crosslinking, curing, etc.). The components of the coating compositions may vary during these stages.

Examples of electrically conductive components include graphene sheets, metals (including metal alloys), conductive metal oxides, conductive carbons, polymers, metal-coated materials, etc. These components can take a variety of forms, including particles, powders, flakes, foils, needles, etc.

Examples of metals include, but are not limited to silver, copper, aluminum, platinum, palladium, nickel, chromium, gold, zinc, tin, iron, gold, lead, steel, stainless steel, rhodium, titanium, tungsten, magnesium, brass, bronze, colloidal metals, etc. Examples of metal oxides include antimony tin oxide and indium tin oxide and materials such as fillers coated with metal oxides. Metal and metal-oxide coated materials include, but are not limited to metal coated carbon and graphite fibers, metal coated glass fibers, metal coated glass beads, metal coated ceramic materials (such as beads), etc. These materials can be coated with a variety of metals, including nickel.

Examples of electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis(3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polyisonaphthalene, polyaniline, polypyrrole, poly(phenylene sulfide), polycarbozoles, polyindoles, polyphenylenes, copolymers of one or more of the foregoing, etc., and their derivatives and copolymers. The conductive polymers may be doped or undoped. They may be doped with boron, phosphorous, iodine, etc.

Examples of conductive carbons include, but are not limited to, graphite (including natural, Kish, and synthetic, annealed, pyrolytic, highly oriented pyrolytic, etc. graphites), graphitized carbon, carbon black, carbon fibers and fibrils, carbon whiskers, vapor-grown carbon nanofibers, metal coated carbon fibers, carbon nanotubes (including single- and multi-walled nanotubes), fullerenes, activated carbon, carbon fibers, expanded graphite, expandable graphite, graphite oxide, hollow carbon spheres, carbon foams, etc.

Graphene sheets are graphite sheets preferably having a surface area of from about 100 to about 2630 m²/g. In some embodiments, the graphene sheets primarily, almost completely, or completely comprise fully exfoliated single sheets of graphite (these are approximately ≦1 nm thick and are often referred to as “graphene”), while in other embodiments, at least a portion of the graphene sheets may comprise partially exfoliated graphite sheets, in which two or more sheets of graphite have not been exfoliated from each other. The graphene sheets may comprise mixtures of fully and partially exfoliated graphite sheets. Graphene sheets are distinct from carbon nanotubes. Graphene sheets may have a “platey” (e.g. two-dimensional) structure and do not have the needle-like form of carbon nanotubes. The two longest dimensions of the graphene sheets may each be at least about 10 times greater, or at least about 50 times greater, or at least about 100 times greater, or at least about 1000 times greater, or at least about 5000 times greater, or at least about 10,000 times greater than the shortest dimension (i.e. thickness) of the sheets. Graphene sheets are distinct from expanded, exfoliated, vermicular, etc. graphite, which has a layered or stacked structure in which the layers are not separated from each other. The graphene sheets do not need to be entirely made up of carbon, but can have heteroatoms incorporated into the lattice or as part of functional groups attached to the lattice. The lattice need not be a perfect hexagonal lattice and may contain defects (including five- and seven-membered rings).

Graphene sheets may be made using any suitable method. For example, they may be obtained from graphite, graphite oxide, expandable graphite, expanded graphite, etc. They may be obtained by the physical exfoliation of graphite, by for example, peeling, grinding, milling, graphene sheets. They made be made by sonication of precursors such as graphite. They may be made by opening carbon nanotubes. They may be made from inorganic precursors, such as silicon carbide. They may be made by chemical vapor deposition (such as by reacting a methane and hydrogen on a metal surface). They may be made by epitaxial growth on substrates such as silicon carbide and metal substrates and by growth from metal-carbon melts. They made by made They may be may by the reduction of an alcohol, such ethanol, with a metal (such as an alkali metal like sodium) and the subsequent pyrolysis of the alkoxide product (such a method is reported in Nature Nanotechnology (2009), 4, 30-33). They may be made from small molecule precursors such as carbon dioxide, alcohols (such as ethanol, methanol, etc.), alkoxides (such as ethoxides, methoxides, etc., including sodium, potassium, and other alkoxides). They may be made by the exfoliation of graphite in dispersions or exfoliation of graphite oxide in dispersions and the subsequently reducing the exfoliated graphite oxide. Graphene sheets may be made by the exfoliation of expandable graphite, followed by intercalation, and ultrasonication or other means of separating the intercalated sheets (see, for example, Nature Nanotechnology (2008), 3, 538-542). They may be made by the intercalation of graphite and the subsequent exfoliation of the product in suspension, thermally, etc. Exfoliation processes may be thermal, and include exfoliation by rapid heating, using microwaves, furnaces, hot baths, etc.

Graphene sheets may be made from graphite oxide (also known as graphitic acid or graphene oxide). Graphite may be treated with oxidizing and/or intercalating agents and exfoliated. Graphite may also be treated with intercalating agents and electrochemically oxidized and exfoliated. Graphene sheets may be formed by ultrasonically exfoliating suspensions of graphite and/or graphite oxide in a liquid (which may contain surfactants and/or intercalants). Exfoliated graphite oxide dispersions or suspensions can be subsequently reduced to graphene sheets. Graphene sheets may also be formed by mechanical treatment (such as grinding or milling) to exfoliate graphite or graphite oxide (which would subsequently be reduced to graphene sheets).

Graphene sheets may be made by the reduction of graphite oxide. Reduction of graphite oxide to graphene may be done by thermal reduction/annealing, chemical reduction, etc. and may be carried out on graphite oxide in a dry form, in a dispersion, etc. Examples of useful chemical reducing agents include, but are not limited to, hydrazines (such as hydrazine (in liquid or vapor forms, N,N-dimethylhydrazine, etc.), sodium borohydride, citric acid, hydroquinone, isocyanates (such as phenyl isocyanate), hydrogen, hydrogen plasma, etc. A dispersion or suspension of exfoliated graphite oxide in a carrier (such as water, organic solvents, or a mixture of solvents) can be made using any suitable method (such as ultrasonication and/or mechanical grinding or milling) and reduced to graphene sheets. Reduction can be solvothermal reduction, in solvents such as water, ethanol, etc. This can for example be done in an autoclave at elevated temperatures (such as those above about 200° C.).

Graphite oxide may be produced by any method known in the art, such as by a process that involves oxidation of graphite using one or more chemical oxidizing agents and, optionally, intercalating agents such as sulfuric acid. Examples of oxidizing agents include nitric acid, nitrates (such as sodium and potassium nitrates), perchlorates, potassium chlorate, sodium chlorate, chromic acid, potassium chromate, sodium chromate, potassium dichromate, sodium dichromate, hydrogen peroxide, sodium and potassium permanganates, phosphoric acid (H₃PO₄), phosphorus pentoxide, bisulfites, etc. Preferred oxidants include KCIO₄; HNO₃ and KCIO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite may also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

One example of a method for the preparation of graphene sheets is to oxidize graphite to graphite oxide, which is then thermally exfoliated to form graphene sheets (also known as thermally exfoliated graphite oxide), as described in US 2007/0092432, the disclosure of which is hereby incorporated herein by reference. The thusly formed graphene sheets may display little or no signature corresponding to graphite or graphite oxide in their X-ray diffraction pattern.

The thermal exfoliation may be carried out in a continuous, semi-continuous batch, etc. process.

Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. vessel. Heating may be done using a flash lamp or with microwaves. During heating, the graphite oxide may be contained in an essentially constant location in single batch reaction vessel, or may be transported through one or more vessels during the reaction in a continuous or batch mode. Heating may be done using any suitable means, including the use of furnaces and infrared heaters.

Examples of temperatures at which the thermal exfoliation and/or reduction of graphite oxide can be carried out are at least about 150° C., at least about 200° C., at least about 300° C., at least about 400° C., at least about 450° C., at least about 500° C., at least about 600° C., at least about 700° C., at least about 750° C., at least about 800° C., at least about 850° C., at least about 900° C., at least about 950° C., at least about 1000° C., at least about 1100° C., at least about 1500° C., at least about 2000° C., and at least about 2500° C. Preferred ranges include between about 750 about and 3000° C., between about 850 and 2500° C., between about 950 and about 2500° C., between about 950 and about 1500° C., between about 750 about and 3100° C., between about 850 and 2500° C., or between about 950 and about 2500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature may vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets may be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used may be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature may vary within these ranges.

The heating may be done under a variety of conditions, including in an inert atmosphere (such as argon or nitrogen) or a reducing atmosphere, such as hydrogen (including hydrogen diluted in an inert gas such as argon or nitrogen), or under vacuum. The heating may be done in any appropriate vessel, such as a fused silica or a mineral or ceramic vessel or a metal vessel. The materials being heated including any starting materials and any products or intermediates) may be contained in an essentially constant location in single batch reaction vessel, or may be transported through one or more vessels during the reaction in a continuous or batch reaction. Heating may be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g., or of least about 700 m²/g, or of least about 800 m²/g, or of least about 900 m²/g, or of least about 700 m²/g. The surface area may be about 400 to about 1100 m²/g. The theoretical maximum surface area can be calculated to be 2630 m²/g. The surface area includes all values and subvalues therebetween, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest).

Surface area can be measured using either the nitrogen adsorption/BET method at 77 K or a methylene blue (MB) dye method in liquid solution.

The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations.

The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets may have a bulk density of from about 0.01 to at least about 200 kg/m³. The bulk density includes all values and subvalues therebetween, especially including 0.05, 0.1, 0.5, 1, 5, 10, 15, 20, 25, 30, 35, 50, 75, 100, 125, 150, and 175 kg/m³.

The graphene sheets may be functionalized with, for example, oxygen-containing functional groups (including, for example, hydroxyl, carboxyl, and epoxy groups) and typically have an overall carbon to oxygen molar ratio (C/O ratio), as determined by bulk elemental analysis, of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 15:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets may contain atomic scale kinks. These kinks may be caused by the presence of lattice defects in, or by chemical functionalization of the two-dimensional hexagonal lattice structure of the graphite basal plane.

The graphene sheets can used with graphite (including natural, Kish, and synthetic, annealed, pyrolytic, highly oriented pyrolytic, etc. graphites). In some cases, the graphite can be present in from about 1 to about 99 percent, or from about 10 to about 99 percent, or from about 20 to about 99 percent, from about 30 to about 99 percent, or from about 40 to about 99 percent, or from about 50 to about 99 percent, or from about 60 to about 99 percent, or from about 70 to about 99 percent, or from about 80 to about 99 percent, or from about 85 to about 99 percent, or from about 90 to about 99 percent, or from about 1 to about 95 percent, or from about 10 to about 95 percent, or from about 20 to about 95 percent, from about 30 to about 95 percent, or from about 40 to about 95 percent, or from about 50 to about 95 percent, or from about 60 to about 95 percent, or from about 70 to about 95 percent, or from about 80 to about 95 percent, or from about 85 to about 95 percent, or from about 90 to about 95 percent, or from about 1 to about 80 percent, or from about 10 to about 80 percent, or from about 20 to about 80 percent, from about 30 to about 80 percent, or from about 40 to about 80 percent, or from about 50 to about 80 percent, or from about 60 to about 80 percent, or from about 70 to about 80 percent, or from about 1 to about 70 percent, or from about 10 to about 70 percent, or from about 20 to about 70 percent, from about 30 to about 70 percent, or from about 40 to about 70 percent, or from about 50 to about 70 percent, or from about 60 to about 70 percent, or from about 1 to about 60 percent, or from about 10 to about 60 percent, or from about 20 to about 60 percent, from about 30 to about 60 percent, or from about 40 to about 60 percent, or from about 50 to about 60 percent, or from about 1 to about 50 percent, or from about 10 to about 50 percent, or from about 20 to about 50 percent, from about 30 to about 50 percent, or from about 40 to about 50 percent, or from about 1 to about 40 percent, or from about 10 to about 40 percent, or from about 20 to about 40 percent, from about 30 to about 40 percent, from about 1 to about 30 percent, or from about 10 to about 30 percent, or from about 20 to about 30 percent, or from about 1 to about 20 percent, or from about 10 to about 20 percent, or from about 1 to about 10 percent, based on the total weight of graphene sheets and graphite.

The graphene sheets may comprise two or more graphene powders having different particle size distributions and/or morphologies. The graphite may also comprise two or more graphite powders having different particle size distributions and/or morphologies.

The coatings can be based on paints, latexes, rosins, lacquers, shellacs, drying oils, etc. When used, the polymeric binders can be thermosets, thermoplastics, non-melt processable polymers, etc. Polymers can also comprise monomers that can be polymerized before, during, or after the application of the coating to the substrate. Polymeric binders can be crosslinked or otherwise cured after the coating has been applied to the substrate. Examples of polymers include, but are not limited to polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral) (PVB), poly(vinyl formal), poly(methyl methacrylate) and other acrylate polymers and copolymers (such as methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), poly(vinyl acetate) and poly(vinyl acetate) copolymers, poly(vinyl pyrrolidone) and poly(vinyl pyrrolidone) copolymers, vinyl acetate and vinyl pyrrolidone copolymers, polycarbonates (PC), polyamides, polyesters, liquid crystalline polymers (LCPs), poly(lactic acid) (PLA), poly(phenylene oxide) (PPO), PPO-polyamide alloys, polysulfone (PSU), polysulfides, polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), and poly(vinyl chloride), polyurethanes (thermoplastic and thermosetting (including crosslinked polyurethanes such as those crosslinked by amines, etc.)), aramides (such as Kevlar® and Nomex®), polysulfides, polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane), etc.), elastomers, epoxy polymers (including epoxy/polysulfone polymers, epoxy polymers (including crosslinked epoxy polymers such as those crosslinked with polysulfones, amines, etc.), polyureas, alkyds, cellulosic polymers (such as nitrocellulose, ethyl cellulose, ethyl hydroxyethyl cellulose, carboxymethyl cellulose, cellulose acetate, cellulose acetate propionates, and cellulose acetate butyrates), polyethers (such as poly(ethylene oxide), poly(propylene oxide), poly(propylene glycol), oxide/propylene oxide copolymers, etc.), acrylic latex polymers, polyester acrylate oligomers and polymers, polyester diol diacrylate polymers, UV-curable resins, etc.

Examples of elastomers include, but are not limited to, polyurethanes, copolyetheresters, rubbers (including butyl rubbers and natural rubbers), styrene/butadiene copolymers, styrene/ethylene/butadiene/styrene copolymer (SEBS), polyisoprene, ethylene/propylene copolymers (EPR), ethylene/propylene/diene monomer copolymers (EPDM), polysiloxanes, and polyethers (such as poly(ethylene oxide), poly(propylene oxide), and their copolymers).

Examples of polyamides include, but are not limited to, aliphatic polyamides (such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD,6)) and polyterephthalamides such as poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide, the polyamide of hexamethyleneterephthalamide, and 2-methylpentamethyleneterephthalamide), etc. The polyamides may be polymers and copolymers (i.e., polyamides having at least two different repeat units) having melting points between about 120 and 255° C. including aliphatic copolyamides having a melting point of about 230° C. or less, aliphatic copolyamides having a melting point of about 210° C. or less, aliphatic copolyamides having a melting point of about 200° C. or less, aliphatic copolyamides having a melting point of about 180° C. or less, etc. Examples of these include those sold under the trade names Macromelt by Henkel and Versamid by Cognis.

Examples of acrylate polymers include those made by the polymerization of one or more acrylic acids (including acrylic acid, methacrylic acid, etc.) and their derivatives, such as esters. Examples include methyl acrylate polymers, methyl methacrylate polymers, and methacrylate copolymers. Examples include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidyl methacrylates, 2-ethylhexyl acrylate, 2-ethylhexyl methacrylate, hydroxyethyl acrylate, hydroxyethyl(meth)acrylate, acrylonitrile, and the like. The polymers may comprise repeat units derived from other monomers such as olefins (e.g. ethylene, propylene, etc.), vinyl acetates, vinyl alcohols, vinyl pyrrolidones, etc. They may include partially neutralized acrylate polymers and copolymers (such as ionomer resins).

Examples of polymers include Elvacite® polymers supplied by Lucite International, Inc., including Elvacite® 2009, 2010, 2013, 2014, 2016, 2028, 2042, 2045, 2046, 2550, 2552,2614, 2669, 2697, 2776, 2823, 2895, 2927, 3001, 3003, 3004, 4018, 4021, 4026, 4028, 4044, 4059, 4400, 4075, 4060, 4102, etc. Other polymer families include Bynel® polymers (such as Bynel® 2022 supplied by DuPont) and Joncryl® polymers (such as Joncryl® 678 and 682).

Examples of polyesters include, but are not limited to, poly(butylene terephthalate) (PBT), poly(ethylene terephthalate) (PET), poly(1,3-propylene terephthalate) (PPT), poly(ethylene naphthalate) (PEN), poly(cyclohexanedimethanol terephthalate) (PCT)), etc.

In some embodiment, the polymer has a acid number of at least about 5, or at least about 10, or at least about 15, or at least about 20.

In some embodiments, the glass transition temperature of at least one polymer is no greater than about 100° C., 90° C., or no greater than about 80° C., or no greater than about 70° C., or no greater than about 60° C., or no greater than about 50° C., or no greater than about 40° C.

Examples of solvents include water, distilled or synthetic isoparaffinic hydrocarbons (such Isopar® and Norpar® (both manufactured by Exxon) and Dowanol® (manufactured by Dow), citrus terpenes and mixtures containing citrus terpenes (such as Purogen, Electron, and Positron (all manufactured by Ecolink)), terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate, etc.), glycol ethers, ester and alcohols (such as 2-(2-ethoxyethoxyl)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol (such as Hexasol™ (supplied by SpecialChem)), dibasic esters (such as dimethyl succinate, dimethyl glutarate, dimethyl adipate), dimethylsulfoxide (DMSO), 1,3-dimethyl-3,4,5,6-tetrahydro-2(1H)-pyrimidinone (DMPU), imides, amides (such as dimethylformamide (DMF), dimethylacetamide, etc.), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)), aromatic solvents and aromatic solvent mixtures (such as toluene, xylenes, mesitylene, cumene, etc.), petroleum distillates, naphthas (such as VM&P naphtha), and mixtures of two or more of the foregoing and mixtures of one or more of the foregoing with other carriers. Solvents can be low- or non-VOC solvents, non-hazardous air pollution solvents, and non-halogenated solvents.

The coating compositions can contain additives such as dispersion aids (including surfactants, emulsifiers, and wetting aids), adhesion promoters, thickening agents (including clays), defoamers and antifoamers, biocides, additional fillers, flow enhancers, stabilizers, crosslinking and curing agents, conductive additives, etc.

Examples of dispersing aids include glycol ethers (such as poly(ethylene oxide), block copolymers derived from ethylene oxide and propylene oxide (such as those sold under the trade name Pluronic® by BASF), acetylenic diols (such as 2,5,8,11-tetramethyl-6-dodecyn-5,8-diol ethoxylate and others sold by Air Products under the trade names Surfynol® and Dynol®), salts of carboxylic acids (including alkali metal and ammonium salts), and polysiloxanes.

Examples of grinding aids include stearates (such as Al, Ca, Mg, and Zn stearates) and acetylenic diols (such as those sold by Air Products under the trade names Surfynol® and Dynol®).

Examples of adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and others sold by Johnson-Matthey Catalysts under the trade name Vertec.

The coating compositions may optionally comprise at least one “multi-chain lipid”, by which term is meant a naturally-occurring or synthetic lipid having a polar head group and at least two nonpolar tail groups connected thereto. Examples of polar head groups include oxygen-, sulfur-, and halogen-containing, phosphates, amides, ammonium groups, amino acids (including α-amino acids), saccharides, polysaccharides, esters (Including glyceryl esters), zwitterionic groups, etc.

The tail groups may be the same or different. Examples of tail groups include alkanes, alkenes, alkynes, aromatic compounds, etc. They may be hydrocarbons, functionalized hydrocarbons, etc. The tail groups may be saturated or unsaturated. They may be linear or branched. The tail groups may be derived from fatty acids, such as oleic acid, palmitic acid, stearic acid, arachidic acid, erucic acid, arachadonic acid, linoleic acid, linolenic acid, oleic acid, etc.

Examples of multi-chain lipids include, but are not limited to, lecithin and other phospholipids (such as phosphatidylcholine, phosphoglycerides (including phosphatidylserine, phosphatidylinositol, phosphatidylethanolamine (cephalin), and phosphatidylglycerol) and sphingomyelin); glycolipids (such as glucosyl-cerebroside); saccharolipids; sphingolipids (such as ceramides, di- and triglycerides, phosphosphingolipids, and glycosphingolipids); etc. They may be amphoteric, including zwitterionic.

Examples of thickening agents include glycol ethers (such as poly(ethylene oxide), block copolymers derived from ethylene oxide and propylene oxide (such as those sold under the trade name Pluronic® by BASF), long-chain carboxylate salts (such aluminum, calcium, zinc, etc. salts of stearates, oleats, palmitates, etc.), aluminosilicates (such as those sold under the Minex® name by Unimin Specialty Minerals and Aerosil® 9200 by Evonik Degussa), fumed silica, natural and synthetic zeolites, etc.

Examples of thermally conductive additives include metal oxides, nitrides, ceramics, minerals, silicates, etc. Examples include boron nitride, aluminum nitride, alumina, aluminum nitride, berylium oxide, nickel oxide, titanium dioxide, copper(I) oxide, copper (II) oxide, iron(II) oxide, iron(I,II) oxide (magnetite), iron (III) oxide, silicon dioxide, zinc oxide, magnesium oxide (MgO), etc. The coating compositions can be formed by optionally blending the conductive additives with one or more solvents, binders, and/or other additives.

Blending can be done using any suitable method, including wet or dry methods and batch, semi-continuous, and continuous methods. Dispersions, suspensions, solutions, etc. of the conductive additives can be made or processed (e.g., milled/ground, blended, dispersed, suspended, etc.) by using suitable mixing, dispersing, and/or compounding techniques.

For example, components of the compositions, such as one or more of conductive additives, binders, solvents, and/or other components can be processed (e.g., milled/ground, blended, etc. by using suitable mixing, dispersing, and/or compounding techniques and apparatus, including ultrasonic devices, high-shear mixers, ball mills, attrition equipment, sandmills, two-roll mills, three-roll mills, cryogenic grinding crushers, extruders, kneaders, double planetary mixers, triple planetary mixers, high pressure homogenizers, horizontal and vertical wet grinding mills, etc.) Processing (including grinding) technologies can be wet or dry and can be continuous or discontinuous. Suitable materials for use as grinding media include metals, carbon steel, stainless steel, ceramics, stabilized ceramic media (such as cerium yttrium stabilized zirconium oxide), PTFE, glass, tungsten carbide, etc. Methods such as these can be used to change the particle size and/or morphology of the conductive additives, other components, and blends or two or more components.

Components may be processed together or separately and may go through multiple processing (including mixing/blending) stages, each involving one or more components (including blends).

There is no particular limitation to the way in which the conductive additives, and other components are processed and combined. For example, conductive additives may be processed into given particle size distributions and/or morphologies separately and then combined for further processing with or without the presence of additional components. Unprocessed components may be combined with processed components and further processed with or without the presence of additional components. Processed and/or unprocessed components such as conductive additives may be combined with other components, such as one or more binders and then combined with processed and/or unprocessed conductive additives.

After blending and/or grinding steps, additional components may be added to the compositions, including, but not limited to, thickeners, viscosity modifiers, binders, etc. The compositions may also be diluted by the addition of more solvent.

The coatings may be applied to the bristles and/or other stylus components (including handles) using any suitable method, including, but not limited to, painting, pouring, spin casting, solution casting, dip coating, powder coating, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing (a method of which is described in WO 2007/053621, which is hereby incorporated herein by reference), microprinting, pad printing, tampon printing, stencil printing, wire rod coating, drawing, flexographic printing, stamping, xerography, microcontact printing, dip pen nanolithography, laser printing, via pen or similar means, etc. The compositions can be applied in multiple layers.

After they have been applied to the brushes and/or other stylus components, the coatings may be cured using any suitable technique, including air drying and oven-drying (in air or another inert or reactive atmosphere), UV curing, IR curing, drying, crosslinking, thermal curing, laser curing, IR curing, microwave curing or drying, sintering, and the like.

In some embodiments, after drying/curing, the coating compositions can have a conductivity of at least about 10⁻⁸ S/m, or of about 10⁻⁶ S/m to about 10⁵ S/m, or of about 10⁻⁵ S/m to about 10⁵ S/m, or of at least about 0.001 S/m, or of at least about 0.01 S/m, or of at least about 0.1 S/m, or of at least about 1 S/m, or of at least about 10 S/m, or of at least about 100 S/m, or of at least about 1000 S/m, or of at least about 10,000 S/m, or of at least about 20,000 S/m, or of at least about 30,000 S/m, or of at least about 40,000 S/m, or of at least about 50,000 S/m, or of at least about 60,000 S/m, or of at least about 75,000 S/m, or of at least about 10⁵ S/m, or of at least about 10⁶ S/m.

In some embodiments, after drying/curing, the coating compositions can have a sheet resistivity that is be no greater than about 10000 Ω/square/mil, or no greater than about 5000 Ω/square/mil, or no greater than about 1000 Ω/square/mil or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil.

In some embodiments, after drying/curing, the coating compositions can have a thermal conductivity of about 0.1 to about 50 W/(m-K), or of about 0.5 to about 30 W/(m-K), or of about 1 to about 30 W/(m-K), or of about 1 to about 20 W/(m-K), or of about 1 to about 10 W/(m-K), or of about 1 to about 5 W/(m-K), or of about 2 to about 25 W/(m-K), or of about 5 to about 25 W/(m-K).

1. A capacitive touch device stylus, comprising a brush comprising bristles coated with an electrically conductive coating.

2. The stylus of claim 1, further comprising a electrically conductive handle.

3. The stylus of claim 1, wherein the electrically conductive coating comprises at least one electrically conductive component and at least one binder.

4. The stylus of claim 1, wherein the electrically conductive coating comprises at least one conductive component selected from the group consisting of graphene sheets, metals, metal oxides, conductive carbons, graphite, and conductive polymers.

5. The stylus of claim 1, wherein the electrically conductive coating comprises graphene sheets.

6. The stylus of claim 3, wherein the binder is one or more selected from the group consisting of acrylic polymers, epoxies, poly(vinyl butyrals), and polyureas.

7. The stylus of claim 2, wherein the handle comprises an electrically conductive coating.

8. The stylus of claim 2, further comprising a ferrule.

9. The stylus of claim 6, wherein the electrically coating of the handle is overcoated with an electrically insulating coating.

10. A method of making a capacitive touch device stylus, comprising forming a brush from a plurality of bristles, at least a portion of which have been coated with an electrically conductive coating and connecting the brush to a handle through an electrically conductive pathway.

11. The method of claim 10, wherein the electrically conductive coating comprises at least one electrically conductive component and at least one binder.

12. The method of claim 9, wherein the electrically conductive coating comprises at least one conductive component selected from the group consisting of graphene sheets, metals, metal oxides, conductive carbons, graphite, and conductive polymers.

13. The method of claim 9, wherein the electrically conductive coating comprises graphene sheets.

14. The method of claim 9, wherein the handle comprises an electrically conductive coating.

15. The method of claim 10, wherein the electrically conductive coating comprises a binder.

16. The method of claim 15, wherein the binder is one or more selected from the group consisting of acrylic polymers, epoxies, poly(vinyl butyrals), and polyureas.

17. A method of making a capacitive touch device stylus, comprising forming a brush from a plurality of bristles, connecting the brush to a handle through an electrically conductive pathway, and coating the bristles with an electrically conductive coating.

18. The method of claim 17, wherein the electrically conductive coating comprises at least one electrically conductive component and at least one binder.

19. The method of claim 17, wherein the electrically conductive coating comprises at least one conductive component selected from the group consisting of graphene sheets, metals, metal oxides, conductive carbons, graphite, and conductive polymers.

20. The method of claim 17, wherein the electrically conductive coating comprises graphene sheets.

21. The method of claim 17, wherein the handle comprises an electrically conductive coating.

22. The method of claim 17, wherein the electrically coating of the handle is overcoated with an electrically insulating coating

23. A method of operating a capacitive touch device using a stylus having a brush comprising bristles coated with an electrically conductive coating connected to a handle via an electrical conductive pathway, wherein a user contacts the handle with a body part while simultaneously contacting the capacitive touch device with the brush.
